(19) United States
(12) Patent Application Publication
(10) Pub. No.: US 2005/0060177 A1
(43) Pub. Date: Mar. 17, 2005

(54) Method of labeling a virtual product and device for providing labeling for a virtual product

(76) Inventors: Thomas Sporer, Fuerth (DE); Ruediger Grimm, Darmstadt (DE); Juergen Nuetzel, Ilmenau (DE); Marko Langbein, Ilmenau (DE)

Correspondence Address: GLENN PATENT GROUP, 3475 EDISON WAY, SUITE L, MENLO PARK, CA, 94025, US

(21) Appl. No.: 10/931,726

(22) Filed: Aug. 31, 2004

Related U.S. Application Data
(63) Continuation of application No. PCT/EP03/01915, filed on Feb. 25, 2003.

(30) Foreign Application Priority Data
Apr. 22, 2002 (DE) 102 17 862.3

(51) Int. Cl. G06F 17/60

(52) U.S. Cl. 705/1

(57) ABSTRACT

In a method and a device for labeling a virtual product when distributing it to third parties, the virtual product being in a digital form, and the labeling indicating which rights a third party having received the virtual product has acquired in relation to same, the virtual product is initially provided by a distributor in the form of a file. Subsequently, electronic documentation for the virtual product provided is created, which has information regarding the distributor of the virtual product associated with it. Then the electronic documentation thus produced is associated with the file, which is then distributed to a third party. If the third party wishes to acquire rights to the file received, the necessary transactions are performed using the information associated with the electronic documentation so as to distribute a predetermined right to the third party from the distributor of the virtual product. After the transaction is completed, an electronic acknowledgement is created which has information associated with it which relates to the rights the third party has acquired by means of the transaction, and finally the electronic acknowledgement is associated with the file having the associated documentation which has been received by the third party.

### CROSS-REFERENCE TO RELATED APPLICATIONS

This application is a continuation of copending International Application No. PCT/EP03/01915, filed Feb. 25, 2003, which designated the United States and was not published in English.

### BACKGROUND OF THE INVENTION

1. Field of the Invention

The present invention relates to a method of labeling a virtual product and to a device for providing such labeling. In particular, the present invention relates to a method and a device for labeling, or, providing labeling for a virtual product when said product is distributed to third parties, the virtual product being in a digital form, and the identification indicating which rights a third party having received the virtual product has acquired in relation to the virtual product.

2. Description of Prior Art

The term “virtual product” describes intellectual property, such as music, a novel, a picture, a film, a program or the like, which may be represented in a digital form, typically as a file. Files under consideration are, for example, an MP3 file, a PDF file, an AVI file, an EXE file, and the like.

The production and distribution of a virtual product, such as multimedia, are expensive. The production and distribution are organized by a content provider. The latter bears the economic risk for the goods (virtual product). This is the model on which, e.g., the global music industry is based. The same applies to software distribution. Non-legalized copies or pirate copies of multimedia products and software products as well as their non-licensed distribution undermine this economic model. In the case of the music industry, there is the question whether it will be possible, in the future, for production to carry on existing at all, when nobody will be able to pay authors, composers and performers anymore, since their products will no longer have any market value.

As a counter-measure, the software and music industries are trying, for example, to limit the uncontrolled circulation of their products. The software and music industries are faced with a dilemma, however: on the one hand, they want to hand out the product to legal buyers, i.e. to transfer the product to the users' devices and thus to distribute them, or pass them on, to the user's range of influence. There, however, they are only supposed to be of limited availability to the users' desire to use them. However, it is not the content providers that possess the instruments of power for implementing this limitation, but only their users. However, masses of users renounce to being limited in that way—they rather simply carry on spreading the products purchased. The music industry, for example, reacts to this by presenting a security concept obliging the users to utilize players wherein the use of the products is checked upon in the user's device. The product purchased by the user (content stream) has the specification of so-called IPMP elements contained therein (IPMP=Intellectual Property Rights Management and Protection). It is only these IPMP elements that make it possible at all to be able to play the product acquired on a terminal device. The problem associated with this is that every product contains the elements of its decryption, so that the limitations of the IPMP elements may be lifted by suitable reprogramming.

This reprogramming may be performed, for example, by a simple personal computer. The industry standards rely on a large number of customers, the number being significant in terms of the economy, to comply with the functionality of the standardized IPMP devices.

The principle of the common models of rights, e.g. IPMP, provides for an element installed in the terminal device to control the use of a product acquired in the terminal device at the user's end. In particular, it prevents uncontrolled distribution. Here, the individual user's interest is not met. On the contrary, the user is restricted in his/her freedom. Rather, the user is called upon to undermine, by means of his/her device, the distributor's interest, i.e. the prevention of the uncontrolled spreading of the products.

Thus, this model infringes upon a fundamental principle of open security requirements, i.e. that which states that in an open world of communication partners not subject to any central control, those that pursue an interest must also have the means to push through this interest. This is done, e.g., in exchanging signed declarations of intention, acknowledgements, or receipts, and agreements. Those who have an interest in a promise of their communication partner being met, possess, in the form of the partner's signature, a piece of evidence which cannot be disputed by the partner and with which they may enforce the promise being met, if need be before court.

With the IPMP approach, the contrary applies. Those who have an interest in restricting the use of their products hand out the means for enforcing their interests to a communication partner who will be restricted in his interests by these very means.

This provides an explanation for the big success of Internet exchanges, such as Napster and subsequent file-sharing models.

Thus, there is a need to regain a sound basis for the security model for multimedia rights, especially on the Internet.

An approach is to associate any self-limiting good behavior of users with advantages for them which are more enticing than any behavior deviating therefrom. These advantages could be, for example, discounts, the possibility of returning products, or quality warrantees.

More effective than these incentives, however, is the reversal of the above-mentioned nature of the interests involved, i.e. to the effect that the spreading of multimedia products, which spreading is obviously in the users' interest, may also be recognized by the distributors as being in their own interest, and, accordingly, is not inhibited, but, on the contrary, promoted. The content providers' interest must be for the clients (users) to spread the products as much and as widely as possible, which is not at all bizarre, since the distributor of products anyhow is interested in the products being widely circulated. Of course, a fundamental interest of the distributor is that the product distributed should be paid for.

To achieve this, users are made sales partners of the content providers, i.e. they are made nodal points of sale. Users who pay for and circulate a multimedia product or software or similar virtual product are given a commission out of the purchase price that the receiver pays for the product obtained. If the receiver pays no purchase price, the sender will not receive any commission, in which case the receiver, in his/her turn, will also never be entitled to receive a commission fee. In order to enable the abovedescribed approach, the virtual product must be labeled so as to associate the potentially acquired rights to the virtual product.

### SUMMARY OF THE INVENTION

It is the object of the present invention to provide a method and a device which enable the rights to a virtual product which may exist or which may be, as the case may be, acquired, to be assigned to a file of the virtual product.

In accordance with a first aspect, the invention provides a method for labeling a virtual product when distributing same on to third parties, the virtual product existing in a digital form, and the labeling indicating which rights a third party having received the virtual product has acquired in relation to the virtual product, the method comprising:
(a) providing the virtual product by a distributor in the form of a file;
(b) creating electronic documentation for the virtual product provided, the electronic documentation having associated therewith information relating to the distributor of the virtual product;
(c) associating the electronic documentation created with the file;
(d) distributing the file to a third party; and
(e) if the third party having received the file wishes to acquire rights to the virtual product,
   (e.1.) performing the transactions required using the information associated with the electronic documentation so as to obtain, from the distributor of the virtual product, a predetermined right to same;
   (e.2.) upon completion of the transaction, creating an electronic acknowledgement which has information associated therewith which relates to the rights the third party has acquired by means of the transaction; and
   (e.3.) associating the electronic acknowledgement with the file having the associated documentation which has been received by the third party.

If the third party having received the file does not wish to acquire any rights to the virtual product, the file with the associated electronic documentation is preferably maintained in an unchanged form, which indicates that the third party has not acquired any rights to the virtual product.

In addition, the creation of the electronic documentation, the creation of the electronic acknowledgement as well as the performance of the transactions necessary for acquiring the rights are conducted at an exchange point of the distributor of the virtual product or at a decentralized exchange point selected by the distributor.

In accordance with a first preferred embodiment, an archive file is created which contains the file of the virtual product as well as a signature file and a description file. The electronic documentation produced is a file which is added, once it has been produced, to the archive file. Initially, the archive file thus contains only the file for the virtual product, the file for the electronic documentation, the signature file, as well as the description file.

In addition, in this embodiment, the electronic acknowledgement is a file which is added, once it has been created, to the archive file in addition to the files already contained in the archive file. For performing the transactions, the archive file is initially opened, whereupon the file for the electronic documentation, which is contained in the archive file, is transferred to the exchange point, and subsequently the transactions required are conducted on the basis of the information thus received.

In a second preferred embodiment of the present invention, the electronic documentation and the electronic acknowledgement are, in each case, an identification mark associated with the file of the virtual product, the information associated with the electronic documentation and the electronic acknowledgement being stored in the exchange point. The information thus stored may be accessed by means of the identification mark. In this embodiment, the information associated with the file of the virtual product is initially transferred to the exchange point and is stored there, and, subsequently a correspondingly associated identification mark is produced which is then associated with the file of the virtual product. For conducting the transactions for acquiring the rights, the exchange point is accessed, based on the identification mark, by the third party so as to view the respective information. Subsequently, the transactions necessary for transferring the rights are conducted, and finally, a new identification mark is provided which is then associated with the file. Preferably, the identification mark is part of the file name of the file of the virtual product, the original file name initially having appended to it the first identification mark which will be changed in subsequent steps upon the acquisition of rights by a third party.

In accordance with a preferred embodiment, the transaction conducted includes paying for the virtual product, and the rights acquired by the payment for the virtual product include a claim to commission on the part of the third party if the virtual product is purchased, i.e. paid for, by a subsequent recipient after it has been distributed to said recipient.

The payment for the virtual product, which has been performed by means of the transaction, by the third party may, for example, enable utilization of the product which is unlimited in time, and in this case the claim to commission amounts to a sum of money flowing to the third party if, again, a recipient pays for the virtual product once the product has been distributed by the third party. Alternatively, the third party could acquire, by paying a smaller amount of money, utilization of the virtual product which is limited in time, and the third party's commission could comprise granting them prolonged utilization of the virtual product once a further recipient, to whom the third party has distributed the virtual product, has effected payment.

In accordance with a second aspect, the invention provides a device for providing labeling for a virtual product being in a digital form, the labeling indicating which rights a third party having received the virtual product has acquired in relation to same, having:
a data input for receiving data from a distributor of the virtual product and from third parties;
a data output for outputting data to the distributor and to third parties;
a memory storing data provided by the distributor of the virtual product, the data containing information relating to the distributor of the virtual product; and
a processor for creating an electronic documentation associated with the virtual product on the basis of the data stored, and for providing same to the data output for transmission to the distributor, and for effecting, on the basis of the electronic documentation provided by a third party and being present at the data input, a transaction required to associate a predetermined right to the virtual product with the third party, and wherein the processor creates an electronic acknowledgement associated with the virtual product, the acknowledgement containing information regarding the rights acquired by the third party in relation to the virtual product, and provides this electronic acknowledgement to the data output for transmission to the third party.

In accordance with a preferred embodiment of the present invention, the user hereby becomes an exchange partner who pays for and distributes a product and, once a recipient has paid for the product obtained, receives a share of the purchase price. If the recipient does not pay a purchase price, the sender receives no commission, but the recipient, in his/her turn, will also never receive a commission since the payment transaction is acknowledged automatically by the exchange point. The acknowledgement which is signed electronically by the exchange point and contains the name or a pseudonym user identification (user ID) of the buyer, is automatically associated with the virtual product (with its file) in the user's terminal. Hereby the entitlement to commission towards the distributor or towards an exchange point used by the former, e.g. an accounting server (“AS”), is documented. This ensures that a commission is, in principle, only paid out if whoever claims it has paid for the virtual product beforehand. Otherwise, there will be no recognition as an exchange on the part of the distributor. That is, if a third person distributes a product without paying for it, it does not contain the acknowledgement associated with this third party, but that of the previous buyer or the original electronic documentation. As a consequence, in the case of continued distribution, only the previous buyer, if there is one, receives a commission.

With this approach, each user is totally free to decide. He/she may receive, consume and distribute virtual products without worrying about a system of rights. Then he/she does not pay, but he/she does not get anything in return either. On the other hand, he/she may pay for the product and thus acquires the chance of obtaining, when distributing the product, a commission as soon as subsequent recipients pay for the product.

Payment for multimedia products has thus been provided with an incentive which is of economic benefit both for each of the users and the distributors. The non-paid-for distribution is thus by no means prevented, but rendered unattractive. Those who pay for the products and ensure that they are distributed are the users themselves. In addition to there being a centrally controlled distribution structure of the distributor, these users may, by the way, build an alternative, web-like distribution structure organizing and stabilizing itself according to the PGP model from then on. Nobody needs to lose, everybody can win.

### BRIEF DESCRIPTION OF THE DRAWINGS

Preferred embodiments of the present invention will be explained below in more detail with reference to the accompanying figures, wherein:

FIG. 1 shows a flowchart depicting the inventive method in accordance with a first embodiment;

FIG. 2 shows a peer-to-peer system in accordance with the present invention;

FIG. 3 a flowchart depicting the steps, according to a first embodiment, performed with regard to the buyer and the exchange point when receiving and buying the virtual product; and

FIG. 4 shows a flowchart depicting the inventive method in accordance with a second embodiment.

### DESCRIPTION OF PREFERRED EMBODIMENTS

Prior to explaining preferred embodiments in detail below, the basic principle underlying the present invention shall be first of all discussed in more detail.

It shall be assumed that a person has produced a virtual product and wants to commercially distribute it. This person shall be called Fred below. Of course, the person in question need not have produced the product himself/herself, but may have acquired it from a third party, and as the case may be, takes on marketing and commercial exploitation in exchange for appropriate license fees. This may also be done by specialized companies. It shall also be assumed that a server is provided which deals with the central accounting and administration functions, and this server shall be referred to as accounting server (AS). This accounting server will also be referred to as exchange point. For the description that follows it shall be assumed, by way of example, that Fred has produced a music title and that this music title now exists as a file called “MYSONG.MP3”. That is, the virtual product is now the music title which is present in a digital form as a file. The type of the file in question is completely irrelevant for the inventive principle. It could also be an image file, a software or the like.

Now the second step will be taken, which is necessary when Fred works with the AS for the first time. In this situation, Fred logs in at the AS as the author of the music title. For this purpose, various items of information are required, so that the AS may ascertain Fred's identity. Fred is given an author's account on the AS.

In a subsequent, second step, the file “MYSONG.MP3” (only referred to as file below) is registered with the AS. This is effected such that the file may later be re-identified, i.e. by a hash via the file, file name, file length, significant byte sequences of the file or the like. For reasons of effectiveness, deposition of a copy of the file with the AS is preferably dispensed with.

The operator of the AS, referred to as Bill in the following, trusts that Fred also possesses the rights to the registered file. This trust may be increased by a signature of Fred. This signature at least prevents another person from passing himself/herself off as Fred. In the registration of the file, Fred may additionally give a description and the price model desired.

As a confirmation, or proof, of his file registration Fred obtains electronic documentation, i.e. by means of an email, from the AS. The registration documentation, or the documentation information, is now associated with the file, i.e. is attached to it, and may then be sent off along with the file.

Now Fred may distribute his file, along with the registration documentation, via most varied paths. He may, for example, offer the file for downloading on a website on the Internet. In addition, the file may be distributed to a selected group of people, e.g. Fred's friends. Also, the file may be provided in the so called peer-to-peer system. The file may also be distributed on CD ROM.

If a second person, who shall be called Ginny, receives the file with the documentation information, she may play and use the music title “MYSONG” produced by Fred. She may also read the documentation information, or verify them online with the AS. She may also decide to distribute the file and the documentation information, i.e. in the same manner as Fred, or she may buy the music title.

The purchase of the file registered with the AS consists of several individual steps. Initially, Ginny requires a user account on the AS. If this account has not yet been set up, Ginny must transmit the minimum items of information required for opening this account to the AS. Once Ginny's registration with the AS as a user has been completed, or if Ginny has already been a user with the AS, Ginny now transmits, by means of her computer, the documentation information associated with the file to the AS, which may alternatively also be effected at login.

The AS verifies the documentation information obtained and shows Ginny the status of the file. In addition to the price and the price model, the status also contains the level of distribution. Further information, e.g. number of items sold etc., may also be disclosed by the AS. The information indicated and disclosed is, as a matter of principle, specified by Fred when registering the file with the AS.

Ginny may now pay using an online payment system, e.g. Paybest, Micromoney, Paybox, and the like. The purchasing operation is deposited in Fred's account in the AS' database and Fred has the entire amount transferred, also charges deducted, credited to his account.

As a result of this transaction, i.e. of the payment effected, Ginny now receives new documentation, i.e. electronic acknowledgement, which again is attached to the file just like the original electronic documentation (preferably automatically).

Now Ginny may distribute the file with documentation and acknowledgement in the same form as Fred has done. A further person, who shall be called Harry, now obtains the file with documentation and acknowledgement either directly or via other persons who have not paid. Harry now acts analogously to Ginny, but this time, in addition to the documentation information, Ginny's acknowledgement is also transmitted to the AS. After having effected payment, Harry receives a new acknowledgement, this acknowledgement being either added to the file or replacing the valid acknowledgement. Now Ginny has part of the payment credited to her account, as was specified within the framework of the price model. The rest goes to Fred. Depending on the price model specified, it may be that Harry had to pay less than Ginny.

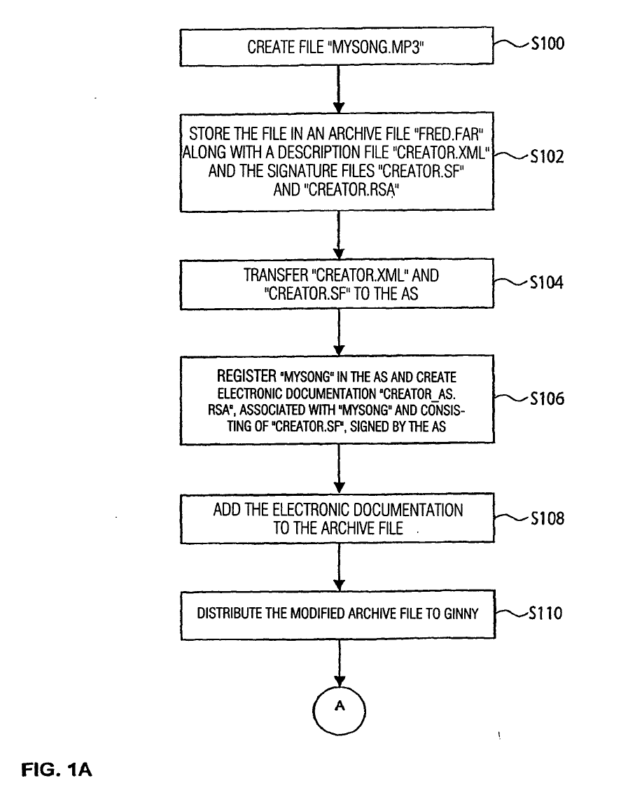

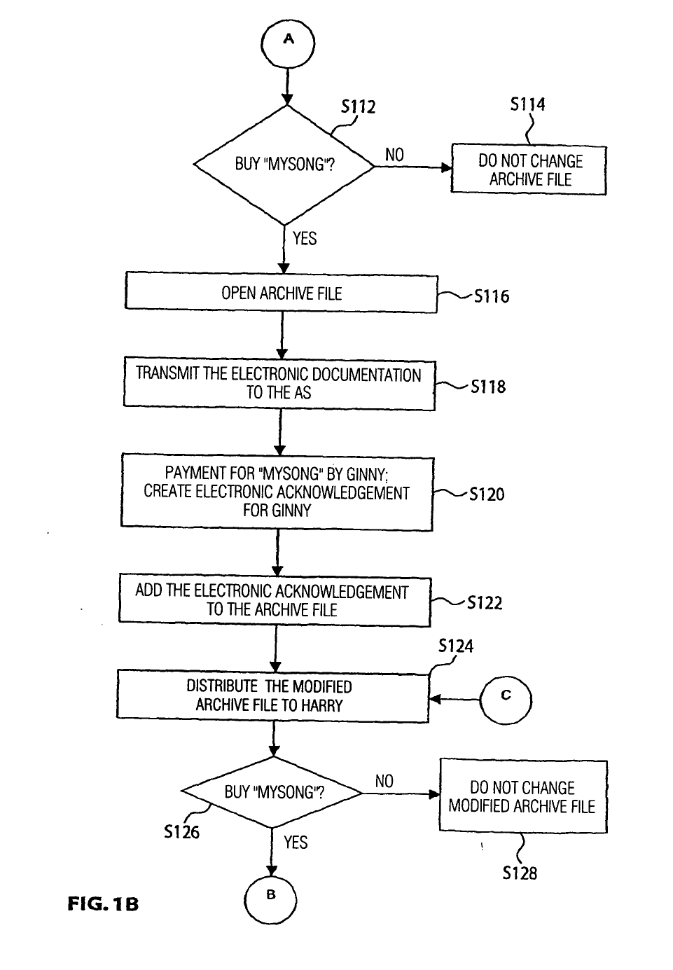

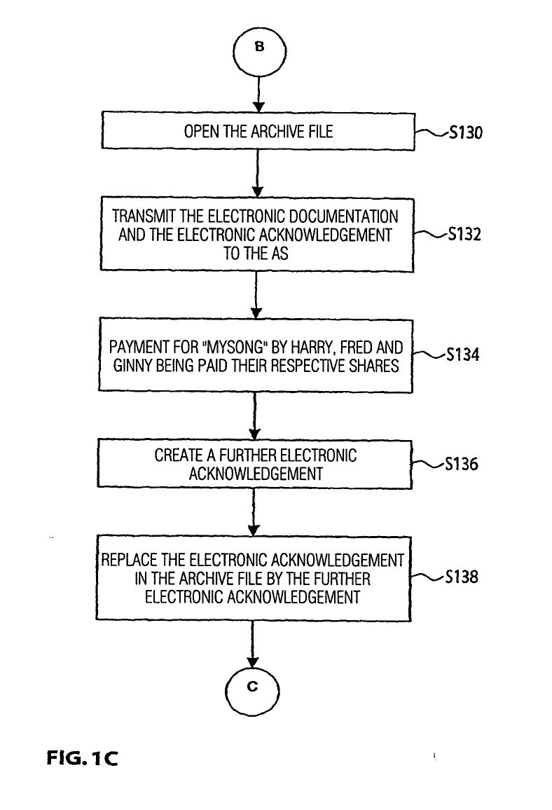

A first preferred embodiment of the present invention will be described below with reference to FIG. 1, the explanation dealing, in particular, with the technical implementation of the processes in the file registration and in the acquisition of the file. This embodiment is referred to as an open-envelope variant, since the file of the virtual product is transported as part of an archive. Since this archive has a disclosed format (ZIP format, JAR format), this transport envelope may be referred to as open. It is the task of the envelope, the archive, to transport documentation information and acknowledgement information along with the file and various signatures.

In addition to the AS already described above, two further components are required which are preferably implemented in software. The first component is referred to as “creator” and is run on Fred's computer.

In a first step S100 Fred, as has already been described above, has produced a file of the virtual product, e.g. file “MYSONG.MP3”. It is the creator's task to embed the file produced in step S100 into the archive, which bears the name FRED.FAR. This archive is similar in structure to the known JAVA archive (JAR). JAVA archives are ZIP archives with specific files. This archive shall be referred to as a “friendly archive” (FAR).

In a step S102 the file is stored in the archive file along with a signature instruction (“CREATOR.SF”) and a signature file (“CREATOR.RSA”) and a description file (“CREATOR.XML”). The signature file contains the author's, i.e. Fred's, signature, who is assumed to possess, for example, a pair of PGP keys. The description file is an XML description file, which is designated, for example, as CREATOR.XML.

The creator's second task is to login the archive thus produced with the AS. The creator creates a connection with the AS and, in step S104, transfers the information CREATOR.XML and CREATOR.SF, i.e. the description file and the signature instruction contained in the archive file, to the exchange point, i.e. the AS. The AS uses the files received to create an account for Fred, and to register, in step S106, the music title and create electronic documentation, associated with the music title, in the form of a file. The documentation is the signature instruction (“CREATOR.SF”) signed by the AS, which will then be referred to as “CREATOR_AS.RSA”. The file of the electronic documentation is transmitted to Fred, along with a password for accessing the account. Once the file for the electronic documentation has been received, this electronic documentation is added to the archive file in step S108.

The “electronic documentation” is created by the AS for the creator, i.e. Fred, of the file and may be used by the creator towards third parties, e.g. Ginny, to whom the file will later be distributed and who, e.g., want to buy the file, as proof that the file corresponding to the virtual product has been logged in and registered with the AS. This documentation remains associated with the file during the entire life cycle of the file. It contains the data of the file “CREATOR.XML”, which data has been signed by the AS. Optionally, the documentation may also contain the creator's signature so as to prove that the creator indicated really is the true creator.

Subsequently, Fred distributes the archive file to third parties in step S110.

It shall be assumed that the archive file is received by a third person, it being necessary, for processing the information provided by the archive file, that the recipients of the archive file have an additional component which is preferably implemented in software and consists of two parts, the opener (opening component) and the redister (re-distribution component). These are installed at the recipient, and the opener opens the FAR archive file and causes the recipient of the file to be asked the question “pay or play” in step S112. If the recipient decides not to buy the music title, the file associated with the music title is temporarily written to a hard disc of the recipient and executed with a suitable application. The archive file remains unchanged (see step S114).

If the recipient, e.g. Ginny, decides to buy the music title off Fred, the redister component is started. The redister enables Ginny to enter into communication with the AS so as to effect payment, downloading of an electronic acknowledgement, and the integration of same into the archive file, which may then be distributed to further persons.

By means of the opener component, in step S116, the archive file is initially opened with Ginny, and a connection to the AS is created on the basis of the information contained therein. In step S118, the data of the electronic documentation is transmitted to the AS, and in step S120, Ginny effects the necessary transactions for paying for the music title. In addition, in step S120, an acknowledgement signed by the AS is created which contains a description file REDIST01.XML as well as two signature files REDIST01.SF and REDIST01.RSA. These files are transmitted to Ginny from the AS, and are integrated into the archive file in step S122, which archive file is subsequently distributed, in step S124, to third parties as a new or modified archive file.

The “electronic acknowledgement” is created by the AS for the buyer, e.g. Ginny, and serves him/her as proof that he/she has purchased the file. The electronic acknowledgement contains the data of REDIST<nn>.XML, <nn> being the number of the distribution level. The electronic acknowledgement is signed by the AS rather than by the creator or the buyer.

A distribution level designates a position of a paying buyer in a distribution chain. The distribution level is a number (generation) designating the generation in a resale chain for a particular file.

If the archive file thus modified is received by a further third party, e.g. by Harry, this further third party will be asked in step S126, similarly to Ginny's case, whether he/she wants to buy the music title. If this is not the case, Harry may listen to the music title, but the modified archive file will remain unchanged (see step S128). In this case, Ginny receives no commission either, since the music title has not been bought by Harry.

If Harry decides to buy the music title, the modified archive file is opened in step S130, similarly to Ginny's case, and on the basis of the information contained therein, a connection to the AS is created, and in step S132, the files contained in the archive file are transferred to the AS.

In step S134, Harry pays for the music title, with Fred, as the distributor of the music title, and Ginny, as a person entitled to commission, being paid their respective shares in accordance with the price model specified by Fred. In other words, Ginny thus receives commission in this case, since Harry has also decided to buy the music title.

The price model may be freely specified by the creator and/or distributor of the file, e.g. Fred, for each distribution level (price, commission and rights of use).

Similarly to Ginny's case, a further electronic acknowledgement is then created for Harry as well as by the AS in step S136. In the embodiment described, Ginny's electronic acknowledgement in the archive file is replaced in step S138, so that the archive file now contains Harry's electronic acknowledgement. Thus, the archive file contains only the “latest” acknowledgement. In other embodiments, several electronic acknowledgements of different persons, who are then also entitled to commission, may alternatively be included. In that case, the archive file contains complete chains of acknowledgements or, alternatively, the acknowledgements of the last few <m> distribution levels.

Once the archive file has been modified by adding Harry's electronic acknowledgement, the process returns to step S124.

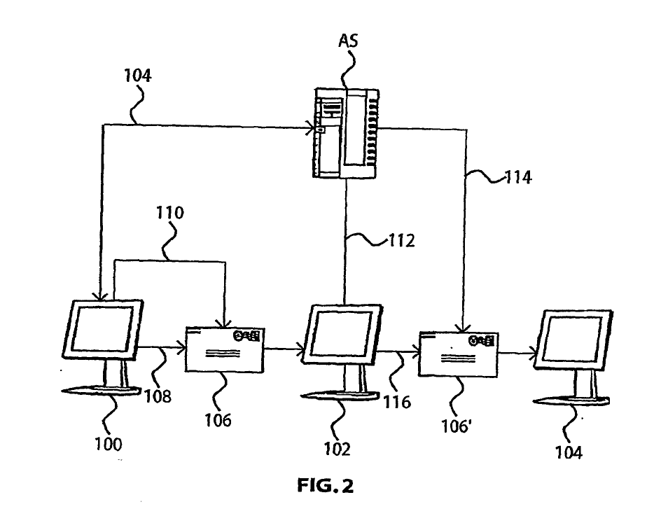

An embodiment of an inventive peer-to-peer system will be described in more detail below with reference to FIG. 2, which system implements the inventive method that has just been described with regard to FIG. 1.

The system includes a plurality of clients 100, 102 and 104 associated with different users. The clients 100 to 104 are, for example, data processing systems, client H100 being associated with the author of the music title MYSONG, FRED. Clients 102 and 104 are associated with users who may receive and buy the music title. Client 100 includes the above-described creator component to enable Fred to register his music title with the AS, as is shown by line 104. Client 100 receives the electronic documentation back from the AS. The music file created by Fred is stored in an envelope 106 (archive file), as is illustrated by arrow 108.

In addition, the electronic documentation received from the AS is introduced into the envelope 106, which is indicated by arrow 110.

Clients 102 and 104 of the third parties include the abovedescribed opener and redister components. Using these components, the envelope 106 distributed by Fred and/or by client 100 is opened by client 102, and the communication with the AS which is necessary for acquiring the rights is conducted, as is indicated by arrows 112 and 114. Client 102 distributes the envelope provided by client 100, which envelope, however, has the electronic acknowledgement added to it, as is indicated by line 116, so that the envelope 106′ results, which will then be distributed to the further user with client 104.

The envelope 106′ received from client 104 now contains all necessary information enabling the overall system to cause Fred to receive his payment, and Ginny to receive her commission, once the third user, Harry, decides to buy the music title.

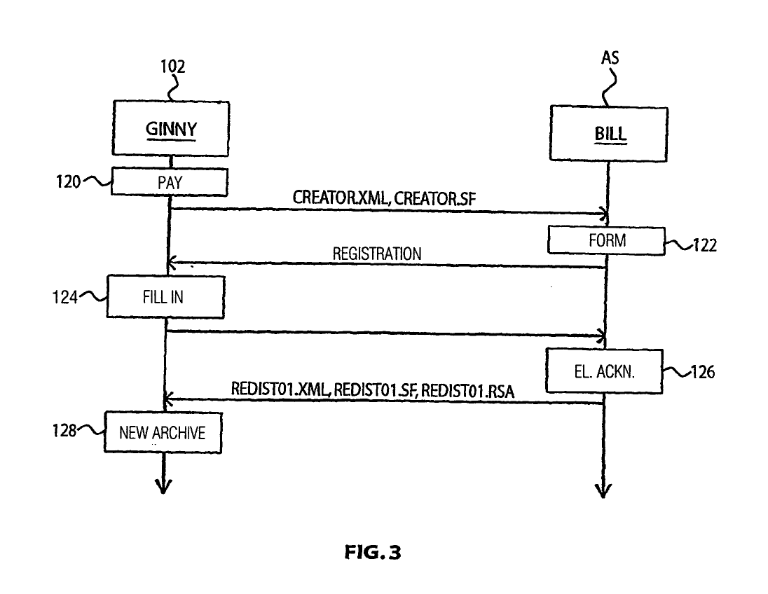

FIG. 3 shows a more detailed flowchart illustrating the steps, in accordance with the first embodiment, conducted at the buyer's and the AS′ side upon the receipt and purchase of the virtual product.

FIG. 3 schematically shows client 102 (Ginny) as well as the AS. Upon receipt of the virtual product, the music title, Ginny actuates the “payment” button 120, whereupon the files CREATOR.XML and CREATOR.SF contained in the envelope 106 are transferred to the AS. The AS creates a form 122 and hands it out to client 102, where it is filled out 124 by Ginny. At the same time, payment is effected. Subsequently, the data required are transferred back to the AS, which creates an account for Ginny and creates the required files for the electronic acknowledgement 126 for Ginny. These files are then given back to Ginny 102 as REDIST01.XML, REDIST01.SF, REDIST01.RSA, client 102 then integrating these files into the existing envelope so as to create a modified envelope 128.

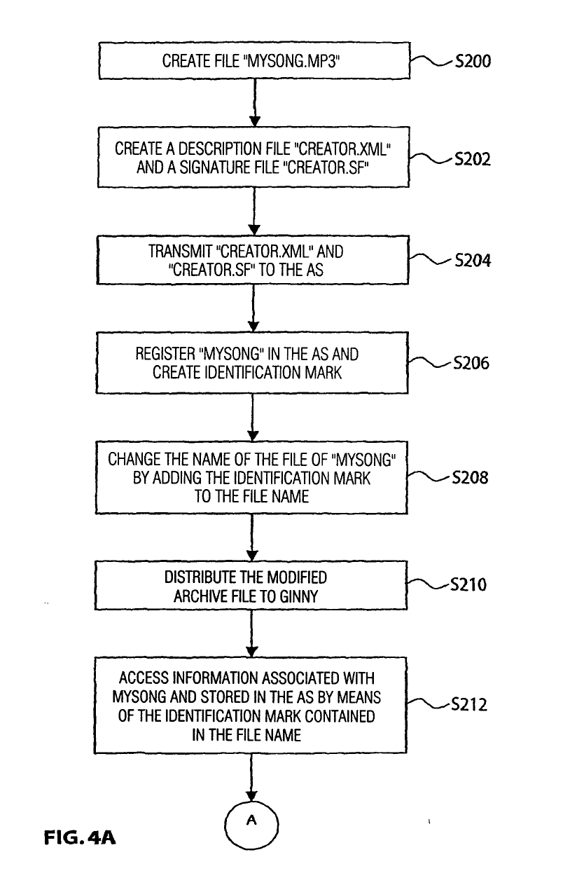

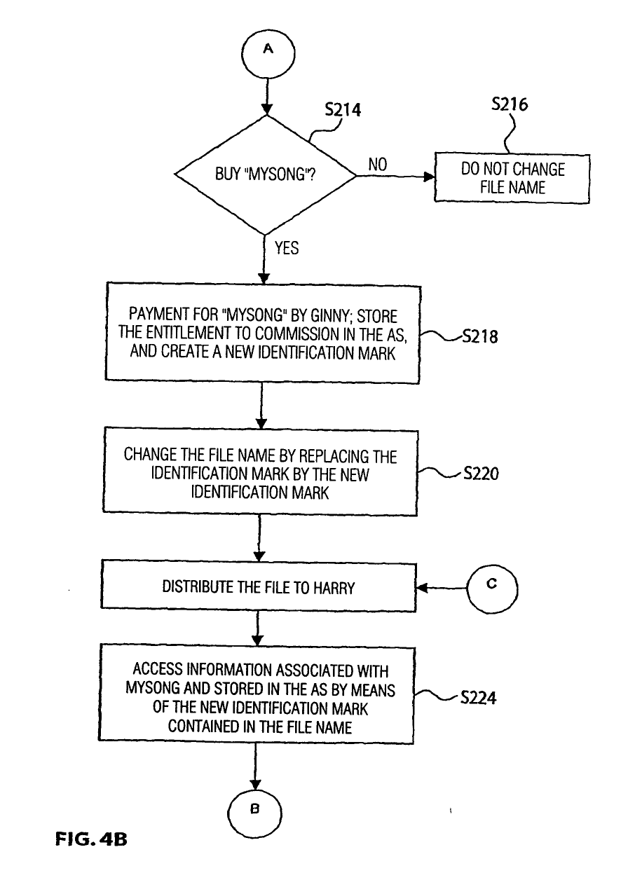

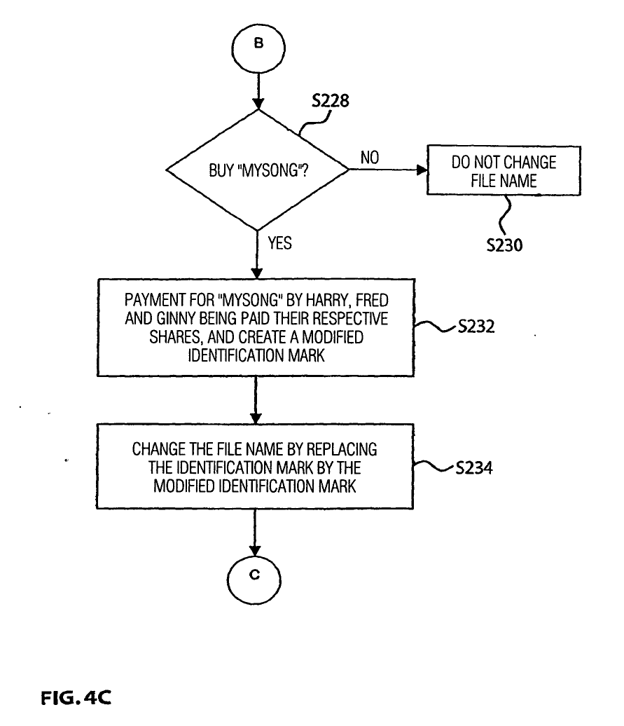

A further preferred embodiment of the present invention will be explained in more detail below with reference to FIG. 4. Unlike the above-described first embodiment, the documentation and acknowledgement information here do not exist as individual files, but are saved in the file name of the file of the virtual product. Just like in the above embodiment it shall be assumed that an author, Fred, has composed a music title and wishes to distribute it to others. In a manner similar to the first embodiment, in step S200 Fred initially creates a file of his music title. Using the creator component, in step 202 Fred creates a description file and a signature file for the music title. The files thus created are transmitted to the AS in step 204, which will then register the music title in step S206. In addition, the AS creates a unique identification mark for the music title, for example in the form of a unique transaction number. This transaction number is then given back to Fred, and in step S208, the creator component causes a change in the file name of the file of the music title by adding the identification mark to the file name.

In contrast to the above-described embodiment, the documentation and acknowledgement information is now no longer present as individual files, but is saved in the file name of the file, which is MYSONG.MP3 in the present embodiment. The information saved in the file name, however, is only a transaction number by means of which the actual information may be requested at the AS. If the transaction number is XYZ, for example, the file name MYSONG.MP3 becomes the new file name MYSONG.XYZ.MP3. The dot of XYZ may be replaced by another suitable separating character or sequence of separating characters (e.g. “4FO”). The benefit of using a significant sequence of separating characters is that it may be employed for searching in the AS. The advantage of the approach in accordance with the second embodiment is that it is now also possible to buy files distributed via a write-once CD capable of multisessions, since the new file names only needs to be written to the directory of the CD.

Once the file name has been changed, the file is now distributed to third parties in step S210.

If a third party has received the product, the process proceeds to step S212. Since no clear text information at all is transmitted along with the file in this embodiment, the recipients must now obtain their information directly from the AS. To this end, a third party, e.g. Ginny, enters the transaction number, e.g. XYZ, which symbolically represents a relatively long combination of letters and numbers, from the file into a website of the AS. If this transaction is valid, the AS responds with an information page, similarly to the first embodiment, detailing the price, the price model, the author, a description, a hash value, or the like. Ginny is now provided with sufficient information to verify that she has not been provided with a different file under this transaction number by mistake.

A poll is made in step 214 as to whether the virtual product should be bought. If the third party decides against the purchase in step S214, the file name will not be changed (see step S214).

However, if the third party decides to buy the virtual product, the process proceeds to step S218, where payment for the music title is effected, the same database operations being executed as have been explained above with reference to FIG. 3. Unlike the first embodiment, however, the AS does not create a new file in step S218, but the information stating that Ginny is entitled to commission now remain with the AS. Ginny only receives a new transaction number which has been created by the AS.

In step S220, the file name of the file received by Ginny is changed by means of the identification mark newly received from the AS by replacing the valid identification mark by the new identification mark. The file name may be changed manually in step S220, and alternatively, the redister component may be implemented such that the necessary steps for renaming the file name are performed automatically by the redister component. A specific extension of the redister component may also rename file names on writeable multisession CDs.

With regard to distributing the virtual product via data carriers (CD), the following examples shall be considered in more detail.

The virtual product, or a file of same, is applied to (stored on) an RW-CDROM (RW=rewritable). By distributing the RW-CD, the virtual product is distributed. As has been mentioned, the RW-CD contains Fred's file or several files, each file already having a file name with a transaction number. There is still some room left on the RW-CD. If a third party (user), e.g. Ginny, receives the RW-CD, he/she may place the RW-CD in a suitable player and only use the file. In addition, there is the possibility of buying the file, i.e. the virtual product. As has been described above, the purchasing transaction causes the creation of a new transaction number, and the file in question is renamed on the RW-CD by writing a new session. Here, it is only the directory that is re-written on the RW-CD.

Instead of distributing it via prepared RW-CDs, a file of a virtual product may also be distributed “physically”. The files thus distributed may also be purchased. As an example, let us consider Ginny walking into a shop to buy a new CD of a performer. In the shop, the MP3-CD is burnt “live”, the file name here already having a transaction number which relates to Ginny, i.e. which labels Ginny as the buyer of the product. If Ginny creates a 1-to-1 copy of the CD and distributes it to Harry, Harry may purchase the CD in the manner described, i.e. via his home PC.

The transaction number may be completely free of information, but may also contain readable partial components, e.g. the reference number of the most recent payer in addition to a customer-specific transaction number.

Since the file can no longer ask the question “pay or play”, the AS's address must be communicated in the distribution. As a parameter, this address might have the transaction number attached to it. Clicking on this link takes the third party directly to the answer page of the AS, where all information about the file and the most recent buyer may be found.

Once Ginny possesses the file with the changed file name, she may distribute the file in step S222.

In step S224, the further recipient accesses the AS, in a manner similar to step S212, by means of the altered transaction number so as to obtain the information necessary for a purchase with regard to the file. If the third party decides against the purchase in step S226, the file name remains unchanged (see step S228).

If the further third party decides in favor of the purchase, the process proceeds to step S230, where Fred's music title is paid for, Fred and Ginny, as persons entitled to commission, being paid their respective shares. Subsequently, the AS creates a modified identification mark which is then transferred to the further third party, Harry, in step S232 and is used there for changing the file name. Subsequently, the process returns to step S222.

The present invention thus provides a method and a device which enable files for virtual products to be labeled, by means of electronic documentation and electronic acknowledgement, such that any rights to the virtual product that third parties may have acquired are uniquely labeled in the file.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A method for labeling a virtual product when distributing same on to third parties, the virtual product existing in a digital form, and the labeling indicating which rights a third party having received the virtual product has acquired in relation to the virtual product, the method comprising:
(a) providing the virtual product by a distributor in the form of a file;
(b) creating electronic documentation for the virtual product provided, the electronic documentation having associated therewith information relating to the distributor of the virtual product;
(c) associating the electronic documentation created with the file;
(d) distributing the file to a third party; and
(e) if the third party having received the file wishes to acquire rights to the virtual product,
(e.1.) performing the transactions required using the information associated with the electronic documentation so as to obtain, from the distributor of the virtual product, a predetermined right to same;
(e.2.) upon completion of the transaction, creating an electronic acknowledgement which has information associated therewith which relates to the rights the third party has acquired by means of the transaction; and
(e.3.) associating the electronic acknowledgement with the file having the associated documentation which has been received by the third party.

2. The method as claimed in claim 1, comprising:
if the third party who has received the file does not wish to acquire any rights to the virtual product, keeping the file having the associated electronic documentation in an unchanged form, which indicates that the third party has not acquired any rights to the virtual product.

3. The method as claimed in claim 1, wherein the third party distributes the file received including the associated electronic documentation and the electronic acknowledgement to a third party, and which method comprises the following steps if the further third party who has received the file wishes to acquire rights to the virtual product:
(f.1.) performing the transactions required using the information associated with the elecronic documentation and the information associated with the electronic acknowledgement so as to obtain, from the distributor of the virtual product, a predetermined right to same;
(f.2.) upon completion of the transaction, creating a further electronic acknowledgement which has information associated therewith which relates to the rights the third party has acquired by means of the transaction; and
(f.3.) associating the further electronic acknowledgement with the file that has been received by the further third party.

4. The method as claimed in claim 3, wherein the steps of creating and associating the further electronic acknowledgement are followed by the step of canceling the association of the third party's electronic acknowledgement with the file.

5. The method as claimed in claim 1, wherein steps (b), (e1), (e2), (f1), (f2) are performed by an exchange point of the distributor or by a decentralized exchange point selected by the distributor.

6. The method as claimed in claim 1, wherein
the electronic documentation is a file in which the information regarding the distributor are stored, the file for the electronic documentation and the file for the virtual product being contained in a common file, the common file initially only containing the file for the virtual product, and the file for the electronic documentation being added to the common file in step (c); and
the electronic acknowledgement and the further electronic acknowledgement being a respective file storing information regarding the rights of the third party and of the further third party, respectively, the file for the electronic acknowledgement and the file for the further electronic acknowledgement being added to the common file in steps (e.3.) and (f.3.), respectively.

7. The method as claimed in claim 6, wherein the common file is an archive file, the archive file additionally containing a signature of the distributor or a description file.

8. The method as claimed in claim 7, wherein step (a) comprises:
storing the file for the virtual product in the archive file along with further information; and
transmitting the description and signature of the distributor contained in the archive file to the exchange point to login the archive file with the exchange point.

9. The method as claimed in claim 7, wherein steps (e.1.) and (f.1.), respectively, comprise:
opening the archive file;
transmitting the data for the electronic documentation, which is contained in the archive file, or transmitting the electronic documentation and the electronic acknowledgement of the third party to the exchange point; and
performing the transaction.

10. The method as claimed in claim 1, wherein the electronic documentation, the electronic acknowledgement and the further electronic acknowledgement are in each case an identification mark associated with the file for the virtual product, the information associated with the electronic documentation, the electronic acknowledgement and the further electronic acknowledgement being stored in the exchange point, wherein the information can be accessed in the exchange point by means of the identification mark.

11. The method as claimed in claim 10, wherein step (a) comprises:
transmitting the information associated with the file for the virtual product to the exchange point; and
storing the information transmitted in the exchange point,
wherein step (b) includes creating an identification mark associated with the file for the virtual product, and
wherein in step (c), the identification mark is transmitted to the distributor and is associated with the file for the virtual product.

12. The method as claimed in claim 10, wherein steps (e.1.) and (f.1.) comprise:
on the basis of the identification mark associated with the file of the virtual product, accessing the exchange point to view the information regarding the virtual product which is stored there;
performing the transaction,
wherein steps (e.2.) and (f.2.) include creating a new identification mark for the file of the virtual product, and
wherein steps (e.3.) and (f.3.) include transmitting the new identification mark to the third party and/or the further third party, and associating the new identification mark with the file of the virtual product.

13. The method as claimed in claim 10, wherein the identification mark is part of the file name of the file of the virtual product, wherein in step (c), the original file name is changed on the basis of the identification mark created in step (b), and wherein in steps (e.3.) and (f.3.), the current file name of the file of the virtual product is changed on the basis of the identification mark created in steps (e.2.) and (f.2.), respectively.

14. The method as claimed in claim 13, wherein the file name and the identification mark are separated by a separating character or by a significant sequence of separating characters.

15. The method as claimed in claim 1, wherein the virtual product is distributed in that the file of the virtual product is offered for download on a website, in that the file of the virtual product is sent to selected persons by means of electronic mail, in that the file of the virtual product is provided to a peer-to-peer system, or in that the file of the virtual product is saved on a data carrier which is distributed.

16. The method as claimed in claim 15, wherein the virtual product is stored on the data carrier, the data carrier being re-writeable, and wherein the virtual product is stored as a file with a file name with a transaction number, and wherein the purchasing transaction causes the creation of a new transaction number and the re-naming of the file concerned on the data carrier, the re-naming including re-writing the directory on the CD.

17. The method as claimed in claim 15, wherein the file of a virtual product is acquired by a third party, and the file is then stored on a data carrier with an identification mark associated with the third party.

18. The method as claimed in claim 1, wherein the transaction performed in step (e.2.) includes payment for the virtual product, and wherein the rights acquired by the third party or the further third party include the third party's or the further third party's entitlement to commission if the virtual product is acquired by a recipient after it has been distributed.

19. A device for providing labeling for a virtual product being in a digital form, the labeling indicating which rights a third party having received the virtual product has acquired in relation to same, comprising:
a data input for receiving data from a distributor of the virtual product and from third parties;
a data output for outputting data to the distributor and to third parties;
a memory storing data provided by the distributor of the virtual product, the data containing information relating to the distributor of the virtual product; and
a processor for creating an electronic documentation associated with the virtual product on the basis of the data stored, and for providing same to the data output for transmission to the distributor, and for effecting, on the basis of the electronic documentation provided by a third party and being present at the data input, a transaction required to associate a predetermined right to the virtual product with the third party, and wherein the processor creates an electronic acknowledgement associated with the virtual product, the acknowledgement containing information regarding the rights acquired by the third party in relation to the virtual product, and provides this electronic acknowledgement to the data output for transmission to the third party.
